(19) United States
(12) Patent Application Publication
(10) Pub. No.: US 2013/0005920 A1
(43) Pub. Date: Jan. 3, 2013

(54) METHOD FOR PRODUCING CNT-PI COMPLEX HAVING EMI SHIELDING EFFECTIVENESS

(75) Inventors: Jiang-Jen Lin, Taipei (TW); Wood-Hi Cheng, Taipei (TW); Yi-Fen Lan, Taipei (TW); Jin-Chen Chiu, Taipei (TW); Jhe-Wei Lin, Taipei (TW); Chia-Ming Chang, Taipei (TW)

(73) Assignee: NATIONAL TAIWAN UNIVERSITY, Taipei (TW)

(21) Appl. No.: 13/612,456

(22) Filed: Sep. 12, 2012

Related U.S. Application Data
(62) Division of application No. 12/826,613, filed on Jun. 29, 2010.

(30) Foreign Application Priority Data
Jul. 1, 2009 (TW) 098122333

(51) Int. Cl. C08L 79/08

(52) U.S. Cl. 525/436

(57) ABSTRACT

A CNT-PI complex primarily includes polyimide (PI) and carbon nanotubes (CNT) dispersed in the polyimide. The method for producing the CNT-PI complex first disperses carbon nanotubes in a solvent by adding a dispersant and using an ultrasonic oscillator. Then the carbon nanotubes dispersion is mixed with polyamic acid to give a CNT-PI dispersion. The CNT-PI dispersion is then dried to form a film or layer of the CNT-PI complex. The dispersant used in this invention is an ionic liquid including organic cations and inorganic anions. The produced CNT-PI complex possesses good electromagnetic shielding effectiveness and presents better networked structures and electrical conductivity.

### CROSS REFERENCE TO RELATED APPLICATIONS

The present application is a division of prior U.S. application Ser. No. 12/826,613 filed Jun. 29, 2010, entitled “CNT-PI COMPLEX HAVING EMI SHIELDING EFFECTIVENESS AND METHOD FOR PRODUCING THE SAME”. The prior U.S. Application claims priority of Taiwan Patent Application No. 098122333, filed on Jul. 1, 2009, the entirety of which is incorporated herein by reference.

### BACKGROUND OF THE INVENTION

1. Field of the Invention

The present invention relates to a CNT-PI (carbon nanotubes-polyimide) complex and a method for producing the same, and particularly to a CNT-PI complex having good electromagnetic interference (EMI) shielding effectiveness. The method for producing the complex includes dispersing carbon nanotubes, mixing with polyamic acid which is then transferred to polyimide by thermal imidization at 100˜360 dgree C.

2. Related Prior Art

Currently, applications of materials used for EMI shielding can be classified into two types. One is to deposit the material having electrical or magnetic conductivity on a substrate. The other is to mix or fill the material having electrical or magnetic conductivity with or in a substrate. Accordingly, electromagnetic waves can be reflected or absorbed by such materials without passing through.

Carbon nanotubes as a material having the above properties have been applied to EMI shielding. For example, in “The Electromagnetic interference of Multi-Walled Carbon Nanotubes-Polymer Composite”, 2006, Hong Chien-Fu mentioned an application of carbon nanotubes mixed in epoxy to EMI shielding. The results indicated that the EMI shielding effectiveness at 1 GHz was only 1.6 dB when 5 wt % of carbon nanotubes was present, which was not satisfactory for practical use. U.S. Pat. No. 7,413,474 mentioned a material having EMI shielding effectiveness which contained carbon nanotubes and polymers such as polyethylene terephthalate (PET), polycarbonate (PC), acrylonitrile butadiene styrene (ABS) and a mixture of PC/ABS. However, no data was disclosed to show their EMI shielding effectiveness.

In addition, how to uniformly disperse carbon nanotubes in a polymer matrix is important. So far, carbon nanotubes can reach the maximum concentration at about 10 wt % but has poor electrical conductivity.

To solve the above problems, the present invention develops a complex made from carbon nanotubes and polymers and having good EMI shielding effectiveness.

### SUMMARY OF THE INVENTION

The object of the present invention is to provide a CNT-PI (carbon nanotubes-polyimide) complex and a method for producing the same, so that the CNT-PI complex has good EMI (electromagnetic interference) shielding effectiveness.

To achieve the above object, the CNT-PI complex of the present invention primarily includes polyimide and carbon nanotubes dispersed in the polyimide. The CNT-PI complex has a thickness of about 850˜10,000 μm and the carbon nanotubes are present in the form of networks in the polyimide. Additionally, the concentration of the carbon nanotubes in the complex is about 10˜50 wt %, and preferably about 25˜30 wt %. One individual carbon nanotube has a diameter of about 30˜60 nm and an electrical conductivity of about 10⁻²˜10^{˜5} Ω.cm. The complex has an electrical conductivity of about 10⁻⁴˜10¹ (S/cm).

The method for producing the CNT-PI complex primarily includes steps: (1) dissolving a dispersant in a solvent and dispersing carbon nanotubes in the solvent containing the dispersant by a magnetic stirrer, ultrasonic vibration or mechanical blending to form a dispersion of the carbon nanotubes, wherein the dispersant is an ionic liquid containing organic cations and inorganic anions; (2) mixing the dispersion of the carbon nanotubes of step (1) with polyamic acid, precursor of polyimide (PI), to form a suspension of CNT and polyamic acid; and (3) thermal imidizating the suspension of step (2) to form a CNT-PI complex having a desired thickness.

In the above step (1), the dispersant is an ionic liquid including organic cations and inorganic anions. The organic cations can be amine, phosphorous, sulfide, pyridine or imidazolium and the inorganic anions can be BF₄⁻, PF₆⁻, SbF₆⁻, NO₃⁻, CF₃SO₃⁻, (CF₃SO₃)₂N⁻, ArSO₃⁻, CF₃CO₂⁻, CH₃CO₂⁻ or Al₂Cl₇. Examples of the dispersant include triethylamine hydrochloride (TEAC), 1-hexadecyl-3-methylimidazolium chloride (HDMIC), dihexadecyl dimethylammonium bromide (DHDDMAB), tributyl hexadecyl phosphonium bromide (TBHDBP), etc. The dispersant in the solvent has a concentration of about 0.1˜5 wt %. The solvent can be N-methyl-2-pyrrolidone (NMP), tetrahydrofuran (THF), dimethyl formamide (DMF), dimethyl acetamide (DMAC) or toluene. The carbon nanotubes in the dispersion has a concentration of about 5˜15 wt %. In the step (1), the carbon nanotubes can be dispersed into the solvent containing the dispersant preferably by ultrasonic vibration.

In the above step (2), the polyamic acid has a concentration about 10˜20 wt %. The polyamic acid can be previously dissolved in a solvent the same as that of step (1). The dispersion of the carbon nanotubes can be mixed with the polyamic acid by a blender and an ultrasonic vibrator.

In the above step (3), the temperature for thermal imidization is about 100˜365° C. The suspensions of CNT and polyamic acid can be previously coated on a substrate and then heated so that the solvent can be removed and then the polyamic acid is transferred to polyimide to achieve the CNT-PI film. A plurality of the films can be further pressed at a proper temperature to obtain a combinative film.

### BRIEF DESCRIPTION OF THE DRAWINGS

FIG. 1 shows the CNT-PI suspensions with different contents of carbon nanotubes.

FIG. 2 shows the CNT-PI thin film.

FIG. 3 shows electrical conductivity of the CNT-PI thin film with different contents of carbon nanotubes.

FIG. 4 shows the SEM image of the CNT-PI thin film.

FIG. 5 shows relationship between the thicknesses of the CNT-PI thin film and EMI shielding effectiveness (SE) thereof.

FIGS. 6 and 7 show the far-field and near-field EMI shielding effectiveness (SE) of the combinative film.

ATTACHMENT 1 shows the dispersing statuses of the ionic liquids in solvents.

### DETAILED DESCRIPTION OF THE PREFERRED EMBODIMENTS

1. Selecting the Dispersant and the Solvent

Prepare four ionic liquids (IL) respectively from triethylamine hydrochloride (TEAC), 1-hexadecyl-3-methylimidazolium chloride (HDMIC), dihexadecyl dimethylammonium bromide (DHDDMAB) and tributyl hexadecyl phosphonium bromide (TBHDBP). Equal amounts of carbon nanotubes are respectively added into the above ionic liquids to form four IL-CNT mixtures. Each of the IL-CNT mixtures is separately mixed with solvents N-methyl-2-pyrrolidone (NMP), tetrahydrofuran (THF) and toluene to obtain solutions containing 15 wt % of carbon nanotubes. The carbon nanotubes used in the preferred embodiments of the present invention have a diameter about 30˜60 nm and an electrical conductivity about 10⁻²˜10⁻⁵ Ω.cm.

Chemical structures of the ions in the above ionic liquids can influence the uniformity and stability of the carbon nanotubes dispersed in the solvents, for example, lengths of side chains, one-arm or two-arm, etc. As shown in ATTACHMENT 1, the carbon nanotubes in TBHDPB perform the best in terms of uniformity. The carbon nanotubes in THF and toluene provide good uniformity and stability even for 12 hours. The carbon nanotubes in NMP also provide good stability for 4 hours. The ionic liquid HDMIC can maintain good stability for 12 hours in THF, and 20 minutes in NMP and toluene. Other ionic liquids such as TEAC having short arms and DHDDMAB having one arm can maintain good stability for 2˜3 hours in NMP.

As NMP is more commonly and frequently used in industries, and thus selected as a solvent in the preferred embodiments of the present invention. HDMIC provides similar dispersion effect as TBHDPB and is selected as a dispersant in the preferred embodiments as HDMIC contains nitrogen which is close to polyimide in structure.

2. Preparing the Suspensions of CNT and Polyamic Acid

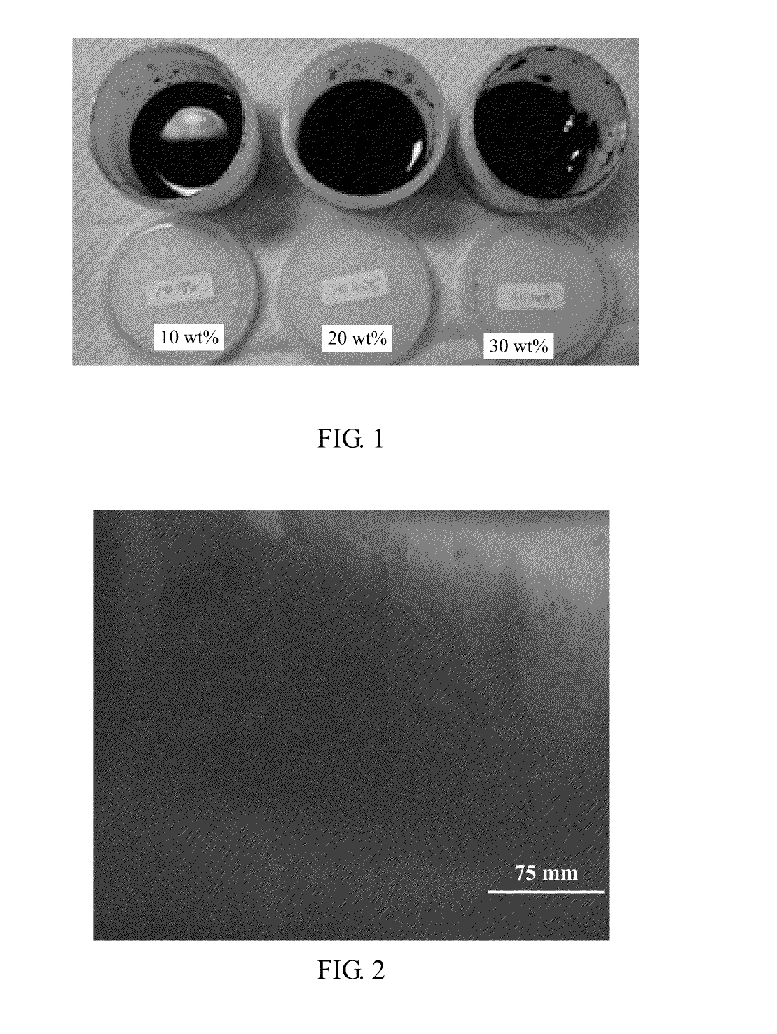

HDMIC (1 wt %) is dissolved in NMP, and then carbon nanotubes are dispersed therein by ultrasonic vibration to form three dispersions respectively containing 10 wt %, 20 wt % and 30 wt % of carbon nanotubes. By means of a blender (2000 rpm) and an ultrasonic vibrator (40 Hz), the above dispersions containing different concentrations of carbon nanotubes are separately mixed with polyamic acid (16 wt %, previously dissolved in NMP) to form CNT-PI suspensions. Polyamic acid is the precursor of polyimide. FIG. 1 shows the result.

3. Preparing the CNT-PI Film by Thermal Imidization

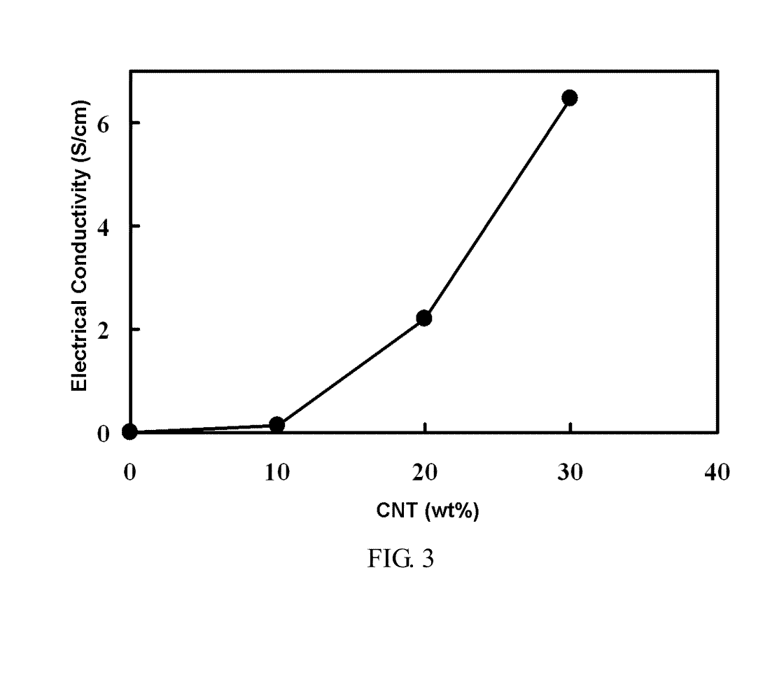

The above suspensions of CNT and polyamic acid are separately coated on glass substrates (210×297 mm) and then placed in an oven (100˜360° C.). The solvent is removed and then the polyamic acid is transferred to polyimide to achieve black thin CNT-PI films with thicknesses ranging 20˜30 μm, as shown in FIG. 2. Finally, forty thin films are pressed at a proper temperature to obtain a combinative film having a thickness of 800˜1000 μm.

Analysis and Test

1. Electrical Conductivity

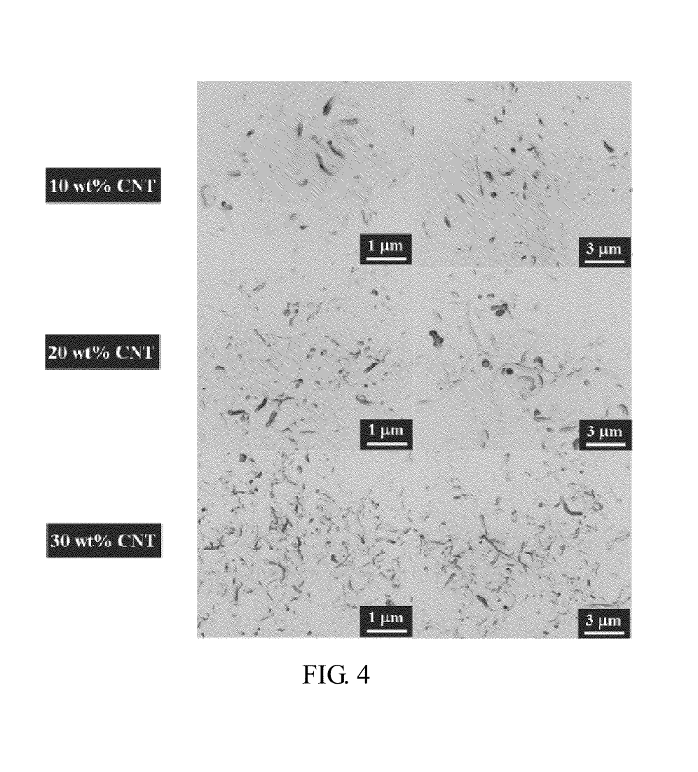

Surface electrical resistance or conductivity of the thin film having a thickness of about 10˜20 μm are measured by means of four-point probe. The results are shown in FIG. 3, in which electrical conductivity increase with contents of carbon nanotubes. Electrical conductivity of the thin film can reach to 10¹ S/cm when the concentration of the carbon nanotubes in the thin film is 30 wt %. Conventionally, 50 wt % of carbon nanotubes is needed to reach 10¹ S/cm of electrical conductivity because of poor dispersion. In the present invention, the carbon nanotubes can be dispersed well, and therefore 30 wt % is enough to reach 10¹ S/cm of electrical conductivity.

2. SEM Analysis

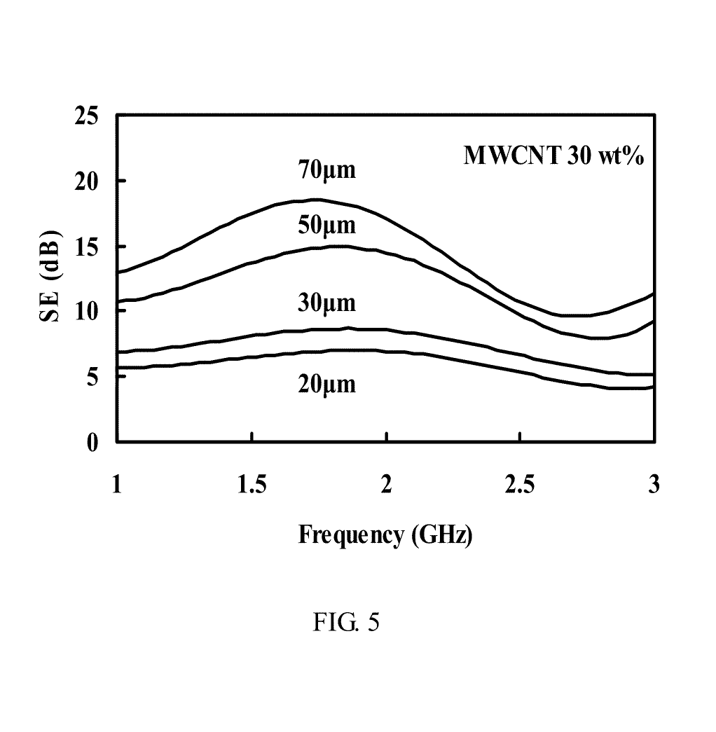

The CNT-PI complex of the present invention is observed by means of scanning electron microscope (SEM). As shown in FIG. 4, the thin film contains the carbon nanotubes loosely dispersed in polyimide when it contains 10 wt % of the nanotubes. Apparently, when the thin film contains 30 wt % of the carbon nanotubes, networks of carbon nanotubes can be observed. In other words, contents of the carbon nanotubes in polyimide can influence forms of the carbon nanotubes in the thin film. Theoretically, when more complete networks of the carbon nanotubes are present, electrical conductivity thereof will increase, as shown in the above measurements.

3. EMI Shielding Effect

A. Relationship between thickness of the CNT-PI thin film and EMI shielding effectiveness

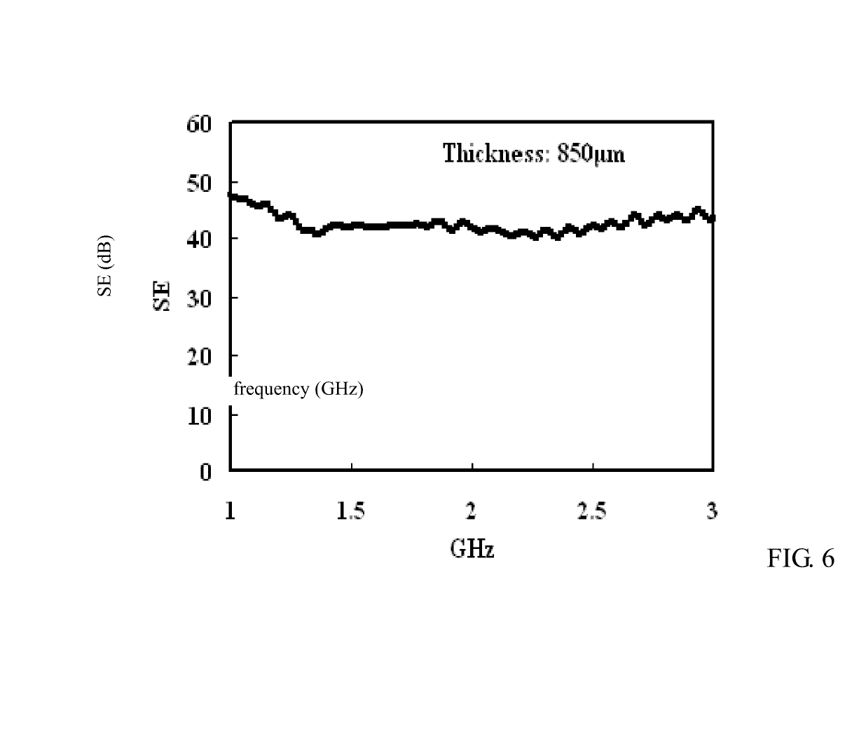

FIG. 5 shows relationship between the thickness of the CNT-PI thin film of the present invention and EMI shielding effectiveness (SE). The results indicate that EMI shielding effectiveness of the thin film increases with its thickness. However, EMI shielding effectiveness becomes acceptable when the thickness of the CNT-PI thin film of the present invention is more than 850 μm. Optimal EMI shielding effectiveness is achieved when the content of the carbon nanotubes is 30 wt %. Therefore, the following measurements are made with thin films having a thickness of 850 μm.

B. Far-Field

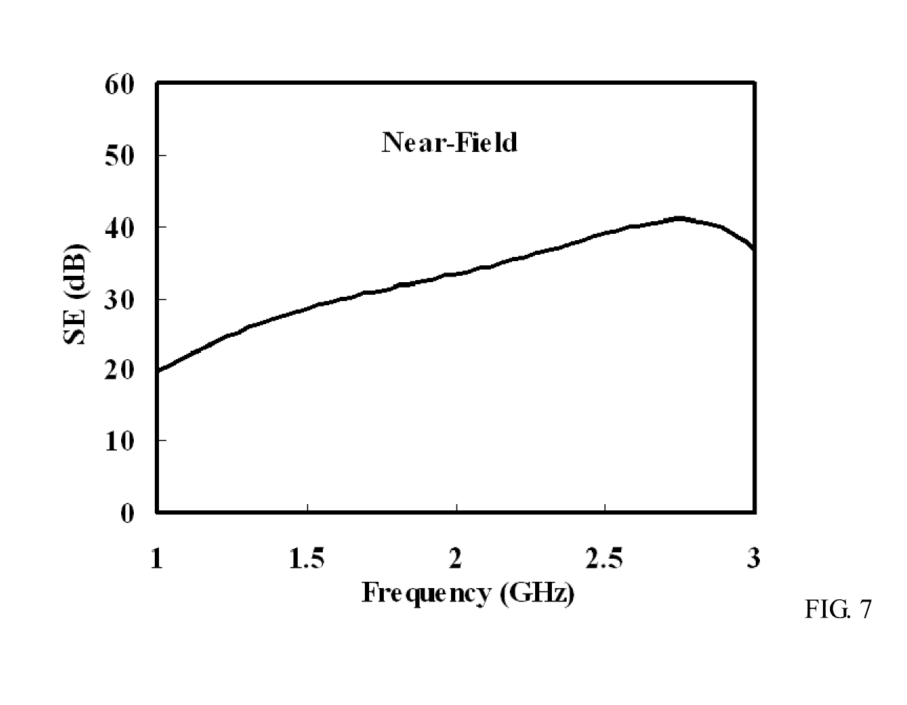

According to ASTM D4935, far-field EMI shielding effectiveness of the combinative film is measured. As shown in FIG. 6, far-field EMI shielding effectiveness (SE) of the combinative CNT-PI film of the present invention can reach 40˜45 dB at 1˜3 GHz.

C. Near-Field

In a laboratory without electromagnetic reflection, a monopole antenna is used as a radiation source. Radiation values of the monopole antenna are measured before and after the combinative film is applied. Difference in the values indicates near-field EMI shielding effectiveness. As shown in FIG. 7, near-field EMI shielding effectiveness (SE) can reach about 37˜42 dB at 2.5˜3 GHz.

4. Eye Mask Margin

According to the SONET OC-48 specification, a monopole antenna is used as an interference source to measure the eye mask margin of an optical receiver module (2.5 Gb/s). The eye mask margin of the optical receiver module shielded with the combinative film indicate that the eye mask margin of the optical receiver module (2.5 Gb/s) increases from 43% to 56% after the combinative film (having a content of carbon nanotubes of 30 wt % and a thickness of 850 μm) is applied. In other words, the combinative film can effectively shield and block the optical receiver module (2.5 Gb/s) from outside EMI.

According to the above, the present invention indeed provides a CNT-PI complex having good EMI shielding effectiveness. The CNT-PI complex presents a better network form and better electrical conductivity, so that EMI shielding effectiveness can be promoted. The CNT-PI complex can be applied to non-metalic and low-resistance flexible substrates, for example, resins and thin films.

| | solvents | | |
|---|---|---|---|
| | N-methyl-2-pyrrolidone | Tetrahydrofuran | |
| ionic liquids | (NMP) | (THF) | Toluene |
| None | + − | + − | + − |
| 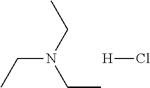 | + (2 hours) | | |
| triethylamine hydrocholoride, TEAC | | | |
| 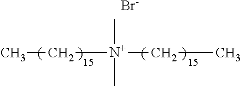 | + (20 minutes) | + (12 hours) | + (20 minutes) |
| dihexadecyl dimethylammonium | | | |
| bromide, DHDDMAB | | | |
| 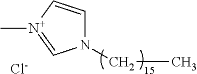 | + (3 hours) | | |
| 1-hexadecyl-3-methylimidazolium | | | |
| chloride, HDMIC | | | |
| 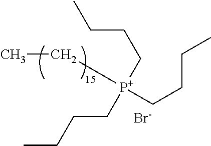 | + (4 hours) | + (12 hours) | + (12 hours) |
| tributyl hexadecyl phosphonium | | | |
| bromide, TBHDBP | | | |

+: dispersing uniformly
−: settling down
+ −: partially dispersing and partially settling down

What is claimed is:

1. A method for producing a CNT-PI complex having EMI shielding effectiveness, comprising steps of:
(1) dissolving a dispersant in a solvent and then dispersing carbon nanotubes (CNT) in the solvent containing the dispersant by magnetic stirrer, ultrasonic vibration or mechanically blending to form a dispersion of CNT, wherein the dispersant is an ionic liquid containing organic cations and inorganic anions;
(2) mixing the dispersion of the carbon nanotubes of step (1) with polyamic acid to form a suspension of CNT and polyamic acid;
(3) thermal imidizing the suspension of step (2) to form a CNT-PI (carbon nanotubes-polyimide) complex having a thickness of about 850˜10,000 μm.

2. The method of claim 1, wherein the organic cation of the dispersant of step (1) is amine, phosphorous, sulfide, pyridine or imidazolium.

3. The method of claim 1, wherein the inorganic anions of the dispersants of the step (1) is BF₄⁻, P F₆⁻, SbF₆⁻, NO₃⁻, CF₃SO₃⁻, (CF₃SO₃)₂N⁻, ArSO₃⁻, CF₃CO₂⁻, CH₃CO₂⁻ or Al₂Cl₇.

4. The method of claim 1, wherein the dispersant of the step (1) is triethylamine hydrochloride (TEAC), 1-hexadecyl-3-methylimidazolium chloride (HDMIC), dihexadecyl dimethylammonium bromide (DHDDMAB) or tributyl hexadecyl phosphonium bromide (TBHDBP).

5. The method of claim 1, wherein the dispersant of the step (1) has a concentration of about 0.1˜5 wt % in the solvent.

6. The method of claim 1, wherein the solvent of the step (1) is N-methyl-2-pyrrolidone (NMP), tetrahydrofuran (THF), dimethyl formamide (DMF), dimethyl acetamide (DMAC) or toluene.

7. The method of claim 1, wherein the carbon nanotubes is dispersed in the solvent containing the dispersant of the step (1) by ultrasonic vibration.

8. The method of claim 1, wherein the carbon nanotubes of the step (1) has a concentration about 5˜15 wt % in the dispersion.

9. The method of claim 1, wherein the dispersion of the carbon nanotubes and the polyamic acid of the step (2) are mixed by a blender and an ultrasonic vibrator.

10. The method of claim 1, wherein the polyamic acid of the step (2) is a solution having a concentration about 10˜20 wt %.

11. The method of claim 1, wherein the polyamic acid of the step (2) is previously dissolved in a solvent the same as that of the step (1).

12. The method of claim 1, wherein the step (3) is controlled at about 100˜365° C. for thermal imidization.

13. The method of claim 1, wherein the CNT-PI complex of the step (3) contains about 10˜50 wt % of the carbon nanotubes.

14. The method of claim 1, wherein the CNT-PI complex of the step (3) contains about 30 wt % of the carbon nanotubes.

15. The method of claim 1, wherein the CNT-PI complex of the step (3) has an electrical conductivity of about 10⁻⁴˜10¹ (S/cm).
